(19) United States
(12) Patent Application Publication
(10) Pub. No.: US 2007/0084148 A1
(43) Pub. Date: Apr. 19, 2007

(54) Feeding system of bakery products to wrappers

(76) Inventor: Sergio Mejia Cuan, Chihuahua (MX)

Correspondence Address: FISH & RICHARDSON P.C., P.O. BOX 1022, MINNEAPOLIS, MN, 55440-1022, US

(21) Appl. No.: 11/511,878

(22) Filed: Aug. 29, 2006

(30) Foreign Application Priority Data
Aug. 30, 2005 (MX) PA/A/2005/009222

(51) Int. Cl. B65G 47/26

(52) U.S. Cl. 53/450; 198/419.3

(57) ABSTRACT

A feeding system of bakery products that operates in a synchronized and continuous manner to deposit the bakery products on corresponding wrappers provided on a conveyor. The system includes a supporting structure having at least one grooved guide. The grooved guide extends along a longitudinal length of the feeding system between a first conveyor transporting the bakery products from a previous operation and a wrapping conveyor feeding wrappers to the bakery products. The supporting structure includes a pair of parallel shafts supported at opposing ends on sanitary journal bearings. The shafts include sprockets and a continuous chain having a plurality of drivers to conduct the bakery products. The system conducts bakery products from the first conveyor, along the grooved guide, and deposits the bakery products onto the wrapper conveyor. The system is synchronized so that each bakery product is deposited on a corresponding wrapper being transported on the wrapper conveyor.

### FIELD OF INVENTION

Presented herein are methods and equipment for managing and handling bakery products in the bakery industry. More specifically, disclosed herein is a continuous feeding system to feed bakery products to a feeding conveyor transporting bakery products to wrappers.

### BACKGROUND OF INVENTION

Previously, wrapping bakery products after various processing stages, such as baking, division, spreading, or any other operation, has been a manual process. That is, wrapping bakery products has required a large number of people to accomplish. Consequently, wrapping operations have had large associated production costs, such as high labor costs. Additionally, manual wrapping is unhygienic, due to the manual handling, and results in damage to the bakery products. Manual wrapping has also resulted in relatively low production rates.

### OBJECTIVES OF THE INVENTION

There is presently disclosed a wrapping method and apparatus to decrease processing times, increase productivity, increase operational capacity, and increase processing rates.

Described herein is an automated feeding system to feed bakery products to corresponding wrappers. The automated feeding system synchronously aligns and deposits bakery products onto corresponding wrappers provided on a wrapper conveyor.

The automated feeding system also offers a more compact design by changing a conveying direction of the bakery products when the bakery products are matched to corresponding wrappers. Consequently, the automated feeding system requires less floor space.

The automated feeding system described herein also reduces the overall risk of damaging the bakery products during the manufacturing and wrapping processes.

The automated feeding system also prevents or substantially reduces damaging the bakery product during wrapping.

The automated feeding system also prevents or substantially reduces the risk of contaminating the bakery products.

The automated feeding system also includes the added benefits of being simple and easy to clean and requires less maintenance.

The automated feeding system also reduces production costs while increasing production.

Other objectives and advantages will become apparent upon review of the detailed description and the accompanying illustrative, but nonlimiting, drawings.

### BRIEF DESCRIPTION OF THE INVENTION

There is presently disclosed a feeding system to convey bakery products to corresponding wrappers. The feeding system includes a supporting structure having at least one grooved guide. The grooved guide extends along a longitudinal length of the feeding system between a collinear attached conveyor that brings the bakery products from a previous operation and a wrapping conveyor for feeding wrappers to the bakery products. The supporting structure includes a pair of parallel shafts that are transverse to the grooved guide. Sanitary journal bearings support the shafts at opposite ends thereof. Additionally one of the shafts includes a gear that transmits a driving-motion from the wrapper conveyor. Each shaft also includes at least one “catarina” (also referred to as a “sprocket”). The sprockets on different shafts are paired and aligned in order to retain a continuous chain. Each continuous chain includes a plurality of drivers that follow a cyclic circuit to conduct the bakery products, exiting the attached collinear conveyor, along the grooved guide. The drivers deposit the bakery products onto corresponding wrappers being transported on the wrapper conveyor, which may be arranged at a 90° angle to the grooved guide. The feeding system is synchronized so that each bakery product joins a corresponding wrapper being transported on the wrapper conveyor. Further, the feeding system is automatic and transports the bakery products without damaging the bakery products.

In one embodiment, the feeding system may also include a pair of grooved guides. A collinear conveyor feeds the bakery products from a previous production stage in two rows that are aligned with the grooved guides. The drivers convey the bakery products along the grooved guides in a synchronous manner so that, when the bakery products reach the wrapper conveyor, the bakery products join with corresponding wrappers being transported on the wrapper conveyor. Further, when laterally adjacent bakery products driven along the grooved guides reach the wrapper conveyor, the bakery products are deposited on the wrapper conveyor forming a single, aligned row in which each bakery product is separated from an adjacent bakery product by a predetermined distance.

The drivers of chain circuits may form a substantially “U” shape to reduce a contact area between the drivers and the bakery products, thereby reducing or eliminating damage to the bakery products. The drivers also uniformly propel the bakery products without rotating or changing a position of the bakery products.

Additional aspects, advantages, and novel features of one or more implementations will be better understood as set forth in the following description and accompanying drawings and will also become apparent to those skilled in the art upon examination of the following or upon learning by practice of the invention.

### BRIEF DESCRIPTION OF THE DRAWINGS

The features of the various implementations will be more readily understood with reference to the following description and the attached drawings, wherein:

FIG. 1 shows a perspective view of the automated feeding system to propel bakery products to corresponding wrappers, according to one implementation.

The accompanying drawing is merely illustrative and is not meant to be limiting.

### DETAILED DESCRIPTION OF THE INVENTION

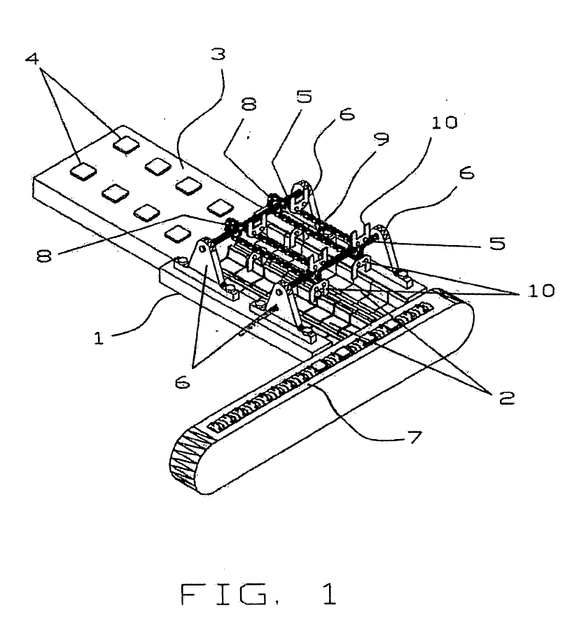

FIG. 1 illustrates a perspective view of a feeding system for feeding bakery products to corresponding wrappers, according to one implementation. The feeding system includes a supporting structure 1 having two attached and parallel grooved guides 2. Although the feeding system is shown with a pair of grooved guides 2, the system may include any number of grooved guides 2. The grooved guides 2 provide a path for bakery products 4 traveling therealong and extend between a collinear attached conveyor 3 and a wrapper conveyor 12 transporting wrappers 7. As shown, the conveyor 3 transports two rows of bakery products 4 from a previous production operation to the grooved guides 2.

The supporting structure 1 also includes a pair of parallel shafts 5. The shafts 5 are disposed transverse to the grooved guides, and sanitary journal bearings 6 support the shafts 5 at opposing ends thereof. At least one of the shafts 5 includes a gear (not shown) that transmits a driving-motion of the wrapping conveyor 12. Each shaft 5 also includes a pair of sprockets 8 which drive corresponding continuous chains 9. Each continuous chain 9 includes a plurality of drivers 10 that follow a cyclic circuit. The drivers 10 propel the bakery products 4 in two rows from the conveyor 3 along the grooved guides 2 and deposit the bakery products 4 onto the wrapper conveyor 12 transporting wrappers 7. As shown, the second conveyor 12 is arranged at a 90° angle relative to the grooved guides 2. Further, the drivers 10 and the second conveyor 12 are synchronized, so that the bakery products 4 are deposited onto a corresponding wrapper 7 when the bakery products 4 exit the grooved guides 2 and are placed on the wrapper conveyor 12. Also, the system is automated and transports the bakery products 4 without damaging the bakery products 4.

The drivers 10 may be substantially “U” shaped to reduce a contact area between the drivers 10 and the bakery products 4, thereby preventing or substantially reducing any damage to the bakery products 4. Additionally, the drivers 10 provide uniform movement without rotating or changing a position of the bakery products 4.

Implementations have now been sufficiently described so that a person with average knowledge in the art would be able to reproduce and obtain the results described herein. Additionally, it will be understood that various modifications may be made without departing from the spirit and scope of the invention. Accordingly, other implementations are within the scope of the following claims.

1-5. (canceled)

6. A system for feeding bakery products to corresponding wrappers, the system comprising:
a supporting structure having at least one grooved guide;
at least two rotatable shafts disposed above and substantially transverse to the at least one grooved guide, each shaft including at least one sprocket; and
a continuous chain extending between the sprockets of adjacent shafts, the chain comprising a plurality of driving mechanisms operable to convey the bakery products along the at least one grooved guide.

7. The system according to claim 6 further comprising a first conveyor operable to convey the bakery products to an inlet end of the at least one grooved guide.

8. The system according to claim 6 further comprising a second conveyor disposed at an outlet end of the at least one grooved guide, wherein the second conveyor is operable to convey bakery product wrappers, and wherein the driving mechanism is operable to deposit the bakery products onto the bakery product wrappers disposed on the second conveyor.

9. The system according to claim 8, wherein the driving mechanisms and the second conveyor are synchronized to deposit a bakery product onto a corresponding bakery product wrapper.

10. The system according to claim 6, wherein the plurality of driving mechanisms are substantially U-shaped with the bottom of the “U” adapted for connection to the continuous chain and the legs of the “U” adapted to contact the bakery product.

11. The system according to claim 6, wherein a shape of the bakery products is at least one of rectangular or quadrangular.

12. A system for feeding bakery products to corresponding wrappers, the system comprising:
a supporting structure having two adjacent grooved guides;
a pair of rotatable shafts disposed above and substantially transverse to the grooved guides, each shaft comprising two sprockets, wherein sprockets on adjacent shafts are aligned;
a chain extending between the aligned sprockets of the adjacent shafts, the chain including a plurality of driving mechanisms operable to convey the bakery products along the adjacent grooved guides;
a first conveyor disposed adjacent to an inlet end of the grooved guides and substantially aligned with the adjacent grooved guides;
a second conveyor disposed adjacent to and substantially perpendicular to an outlet end of the adjacent grooved guides, wherein the second conveyor and the driving mechanisms are synchronized and wherein the driving mechanisms are operable to convey the bakery products along the adjacent grooved guides and to deposit the bakery products onto a corresponding bakery product wrapper provided on the second conveyor.

13. A method for depositing a bakery product onto a corresponding bakery product wrapper, the method comprising:
conveying a plurality of bakery products aligned into at least one row along a first conveyor;
sequentially depositing the plurality of bakery products of the at least one row onto at least one grooved guide aligned with the at least one row along the first conveyor;
conveying the plurality of bakery products along the at least one grooved guide with a driving arrangement comprising parallel shafts arranged substantially transverse to the at least one grooved guide and supported at opposing ends thereof by bearings, the parallel shafts including at least one sprocket, wherein the at least one sprocket on adjacent shafts of the parallel shafts are aligned, the driving arrangement further including a continuous chain extending between the aligned sprockets, each continuous chain including a plurality of substantially U-shaped drivers attached to the continuous chain, wherein the driving arrangement is disposed above and adapted to contact the plurality of bakery products and convey the bakery products along the at least one grooved guide; and
sequentially depositing the plurality of bakery products of the at least one row onto a second conveyor disposed substantially perpendicular to the at least one grooved guide, wherein depositing the plurality of bakery products onto the second conveyor is synchronized so that each bakery product is deposited onto a corresponding bakery product wrapper disposed on the second conveyor.

14. The method according to claim 13, wherein the step of conveying a plurality of bakery products further includes conveying two adjacent aligned rows on the first conveyor, and wherein sequentially depositing the plurality of bakery products onto a second conveyor comprises depositing adjacent bakery products laterally arranged in the two adjacent rows onto the second conveyor to form a single row of bakery products on the second conveyor.

15. The method according to claim 14, wherein the step of conveying bakery products includes conveying each of the adjacent rows of bakery products along a separate grooved guide.
